(19) United States
(12) Patent Application Publication
(10) Pub. No.: US 2018/0144407 A1
(43) Pub. Date: May 24, 2018

(54) SUPPLEMENTAL ELECTRONIC NOTE DATA MESSAGE DISTRIBUTION IN NEAR REAL-TIME

(71) Applicants: Jaclyn E. Pajor, Glastonbury, CT (US); Gaurav Chandrashekhar Patrikar, Concord, NC (US); James S. Rogers, Willington, CT (US); Justin J Thorpe, Charlotte, NC (US); Karen B. Weiss, Scottsdale, AZ (US)

(72) Inventors: Jaclyn E. Pajor, Glastonbury, CT (US); Gaurav Chandrashekhar Patrikar, Concord, NC (US); James S. Rogers, Willington, CT (US); Justin J Thorpe, Charlotte, NC (US); Karen B. Weiss, Scottsdale, AZ (US)

(21) Appl. No.: 15/355,295

(22) Filed: Nov. 18, 2016

(51) Int. Cl. G06Q 40/08

(52) U.S. Cl. CPC G06Q 40/08

(57) ABSTRACT

According to some embodiments, a data store may contain electronic data records each representing an event associated with an existing risk association between an enterprise and an entity. Each electronic data record may be associated with a record identifier and a set of record characteristic values. Moreover, at least some of the electronic data records may be linked to supplemental electronic note data messages. A back-end application computer server, coupled to the data store, may automatically queue new supplemental electronic note data messages in accordance with at least one trigger rule. The computer server may also automatically transmit batches of information about the queued new supplemental electronic note data messages in near real-time. According to some embodiments, information may be exchanged with a plurality of remote management system terminals, via a distributed communication network, to support an interactive user interface display including the supplemental electronic note data messages.

### BACKGROUND

An enterprise might maintain a data store containing a substantial number of electronic data records (e.g., tens of thousands of records) that are periodically updated. Each electronic record, for example, might represent an event associated with an existing risk relationship between the enterprise and an entity and could include a record identifier and a set of record characteristic values. In some cases, at least some of the electronic data records may be linked to supplemental electronic note data messages (e.g., further describing information about the event). Moreover, parties associated with remote management system terminals may be interested in learning the current details associated with a particular electronic data record. Traditionally, the party would need to place a telephone call or send an email message to the enterprise requesting the latest status of the electronic data record (especially with respect to information recently added to the record via a supplemental electronic note data message). This technique might involve, for example, cutting and pasting information (e.g., an electronic data record identifier, record characteristic values, etc.) into the request message. The enterprise might then manually determine the current status of the record and respond to the request. Such an approach, however, can be a time consuming, expensive, and error prone process—especially when a substantial number of requests and/or electronic data records are involved. Further note that it might not be practical to download event information each and every time supplemental electronic note data messages are linked to a record.

It would be desirable to provide systems and methods to automatically make supplemental electronic note data messages available via remote management system terminals in a timely and accurate fashion.

### SUMMARY OF THE INVENTION

According to some embodiments, systems, methods, apparatus, computer program code and means may be provided to automatically make supplemental electronic note data messages available via remote management system terminals in a timely and accurate fashion. In some embodiments, a data store may contain electronic data records each representing an event associated with an existing risk association between an enterprise and an entity. Each electronic data record may be associated with a record identifier and a set of record characteristic values. Moreover, at least some of the electronic data records may be linked to supplemental electronic note data messages. A back-end application computer server, coupled to the data store, may automatically queue new supplemental electronic note data messages in accordance with at least one trigger rule. The computer server may also automatically transmit batches of information about the queued new supplemental electronic note data messages in near real-time. According to some embodiments, information may be exchanged with a plurality of remote management system terminals, via a distributed communication network, to support an interactive user interface display including the supplemental electronic note data messages. According to some embodiments, the back-end application computer server may automatically generate a message in response to an electronic data record and a message trigger rule, wherein the automatically generated message may be a first message type triggered by a first message trigger rule or a second message type triggered by a second message trigger rule, different than the first message trigger rule. In some cases, messages of the first type can include supplemental electronic note data messages while messages of the second type cannot include supplemental electronic note data messages.

Some embodiments comprise: means for receiving, at a back-end application computer server from at least one data store, electronic data records each representing an event associated with an existing risk association between the enterprise and an entity, wherein each electronic data record is associated with a record identifier and a set of record characteristic values, and further wherein at least some of the electronic data records are linked to supplemental electronic note data messages; means for automatically queuing, by the back-end application computer server, new supplemental electronic note data messages in accordance with at least one trigger rule; means for automatically transmitting, by the back-end application computer server, batches of information about the queued new supplemental electronic note data messages in near real-time; and means for exchanging, through a communication port via a distributed communication network, information with a plurality of remote management system terminals to support an interactive user interface display including the supplemental electronic note data messages.

In some embodiments, a communication device associated with a back-end application computer server exchanges information with remote devices. The information may be exchanged, for example, via public and/or proprietary communication networks.

Technical effects of some embodiments of the invention are improved and computerized ways to automatically make supplemental electronic note data messages available via remote management system terminals in a timely and accurate fashion. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a system according to some embodiments.

FIG. 2 illustrates a method according to some embodiments of the present invention.

FIG. 3 is a high-level block diagram of an insurer enterprise system according to some embodiments of the present invention.

FIG. 4 illustrates an exemplary insurance agency management system claims download registration display that might be associated with various embodiments.

FIG. 5 illustrates an exemplary insurance agency management system claim data display according to some embodiments.

FIG. 6 illustrates an exemplary insurance agency management system preference selections display that might be associated with various embodiments.

FIG. 7 is a block architecture diagram of a system in accordance with some embodiments of the present invention.

FIG. 8 is a block architecture diagram of a system in accordance with another embodiment.

FIG. 9 illustrates an exemplary insurance claim handling system claims adjuster data entry display that might be associated with various embodiments.

FIG. 10 illustrates a back-end computer server apparatus or platform according to some embodiments.

FIG. 11 is a portion of a tabular claims download database in accordance with some embodiments.

FIG. 12 illustrates a tablet computer displaying information according to some embodiments.

FIG. 13 illustrates an overall insurance enterprise workflow in accordance with some embodiments.

### DETAILED DESCRIPTION

The present invention provides significant technical improvements to facilitate electronic messaging and dynamic data processing. The present invention is directed to more than merely a computer implementation of a routine or conventional activity previously known in the industry as it significantly advances the technical efficiency, access and/or accuracy of communications between devices by implementing a specific new method and system as defined herein. The present invention is a specific advancement in the area of electronic record analysis and management by providing benefits in data accuracy, data availability, and data timeliness and such advances are not merely a longstanding commercial practice. The present invention provides improvement beyond a mere generic computer implementation as it involves the processing and conversion of significant amounts of data in a new beneficial manner as well as the interaction of a variety of specialized client and/or third-party systems, networks, and subsystems. For example, in the present invention information may be transmitted to remote devices from a back-end application server and electronic records may be updated as appropriate, thus improving the overall performance of the system associated with message storage requirements and/or bandwidth considerations (e.g., by reducing the number of messages that need to be stored and/or transmitted via a network). Moreover, embodiments associated with facilitating the distribution of information via remote system management terminals further improve communication network performance, user interactions, real-time chat or telephone call center responsiveness (e.g., by reducing the amount hardware asset resources required to respond to manual requests), etc.

An enterprise might maintain a data store containing a substantial number of electronic data records that are periodically updated. Each electronic record, for example, might represent an event associated with an existing risk relationship between the enterprise and an entity. In some cases, at least some of the electronic data records may be linked to supplemental electronic note data messages. Moreover, parties associated with remote management system terminals may be interested in learning the current details associated with a particular electronic data record. Manually providing information in response to a request from a party can be a time consuming, expensive, and error prone process—especially when a substantial number of requests and/or electronic data records are involved. Further note that it might not be practical to download event information each and every time supplemental electronic note data messages are linked to a record.

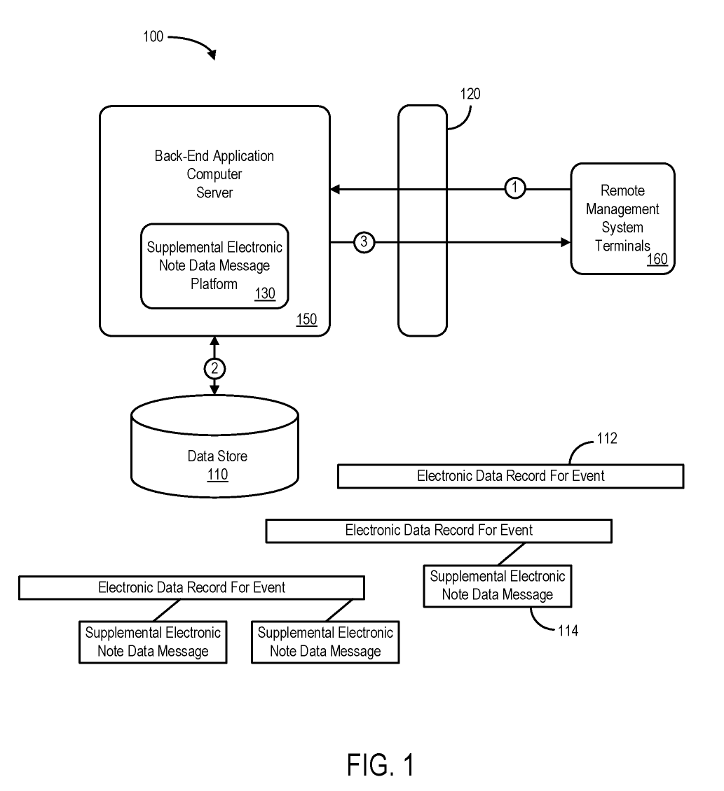

It would be desirable to provide systems and methods to automatically make supplemental electronic note data messages available via remote management system terminals in a timely and accurate fashion. FIG. 1 is a high-level block diagram of a system 100 according to some embodiments of the present invention. In particular, the system 100 includes a back-end application computer server 150 that may access information in a data store 110 (e.g., storing a set of electronic data records for events 112, associated supplemental electronic note data messages 114, etc.). The back-end application computer server 150 may also exchange information with remote management system terminals 160 (e.g., via a firewall 120). According to some embodiments, a supplemental electronic note data message platform 130 of the back-end application computer server 150 may facilitate the distribution of information about supplemental electronic note data messages 114 via one or more remote administrator management system terminals 160. Note that embodiments may be associated with periodic (or asynchronous) types of updates and transmissions. Further note that the back-end application computer server 150 might be associated with a third-party, such as a vendor that performs a service for an enterprise.

The back-end application computer server 150 might be, for example, associated with a Personal Computer (“PC”), laptop computer, smartphone, an enterprise server, a server farm, and/or a database or similar storage devices. According to some embodiments, an “automated” back-end application computer server 150 may automatically facilitate the distribution of information about supplemental electronic note data messages 114. As used herein, the term “automated” may refer to, for example, actions that can be performed with little (or no) intervention by a human.

As used herein, devices, including those associated with the back-end application computer server 150 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the data store 110. The data store 110 might, for example, store a set of electronic records representing events, each electronic record being associated with a different record identifier, record characteristic values, attribute variables, etc. The data store 110 may also contain information about past and current interactions with parties. The data store 110 may be locally stored or reside remote from the back-end application computer server 150. As will be described further below, the data store 110 may be used by the back-end application computer server 150 to automatically facilitate a distribution of information about supplemental electronic note data messages 114. Although a single back-end application computer server 150 is shown in FIG. 1, any number of such devices may be included. Moreover, various devices described herein might be combined according to embodiments of the present invention. For example, in some embodiments, the back-end application computer server 150 and data store 110 might be co-located and/or may comprise a single apparatus.

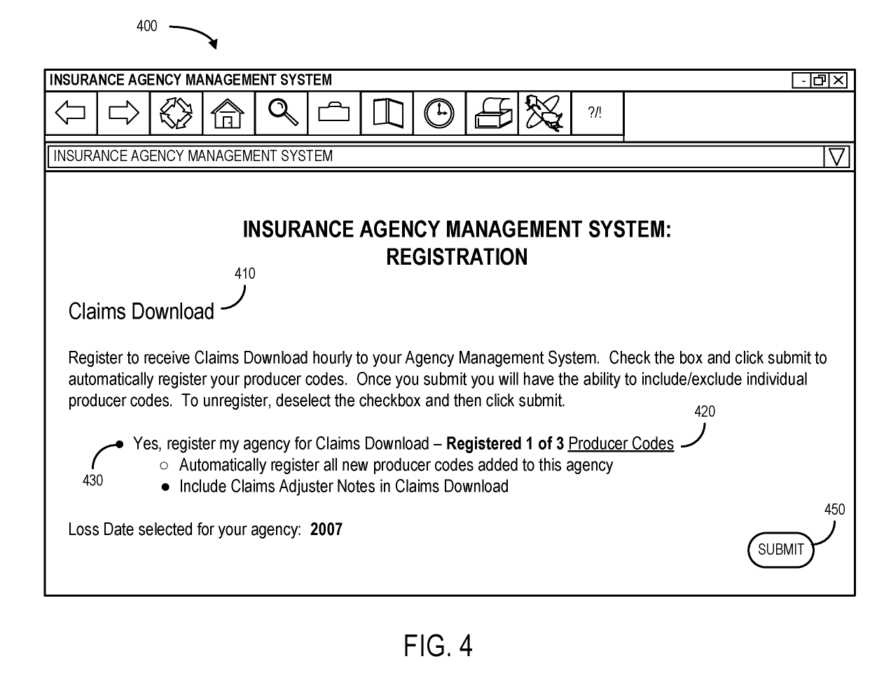

According to some embodiments, the system 100 may automatically route information about supplemental electronic note data messages 114 via the automated back-end application computer server 150. For example, at (1) a remote management system terminal 160 may register with the enterprise associated with the system 100 (as described with respect to FIG. 4). The supplemental electronic note data message platform 130 may then access information in the data store 110 at (2) and exchange information with a remote management system terminal at (3) to support an interactive user interface display (e.g., including an indication of one or more supplemental electronic note data messages 114). The system 100 might also automatically transmit information to the remote management system terminals 160 and/or a messaging server, workflow apparatus, etc. (not illustrated in FIG. 1).

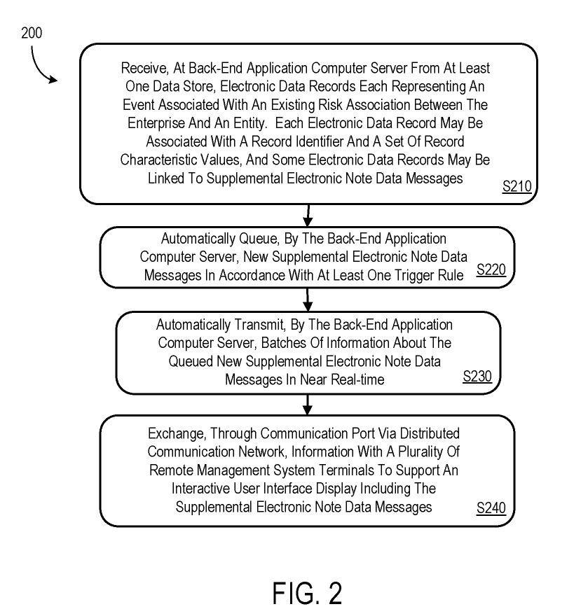

Note that the system 100 of FIG. 1 is provided only as an example, and embodiments may be associated with additional elements or components. According to some embodiments, the elements of the system 100 automatically support interactive user interface displays over a distributed communication network. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a back-end application computer server may receive, from at least one data store, electronic data records each representing an event associated with an existing risk association between the enterprise and an entity. According to some embodiments, each electronic data record is associated with a record identifier and a set of record characteristic values. Moreover, at least some of the electronic data records are linked to supplemental electronic note data messages.

According to some embodiments, the back-end application computer server may automatically generate a message in response to an electronic data record and a message trigger rule, wherein the automatically generated message may be a first message type triggered by a first message trigger rule or a second message type triggered by a second message trigger rule (different than the first message trigger rule). In some cases, messages of the first type can include supplemental electronic note data messages while messages of the second type cannot include supplemental electronic note data messages.

At S220, the back-end application computer server may queue new supplemental electronic note data messages in accordance with at least one trigger rule. According to some embodiments, each supplemental electronic note data message is associated with a note type and the trigger rule is based at least in part on the note type. For example, the trigger rule might further be based on user preference values stored in connection with the remote management system terminals (e.g., indication that a particular user is not interested in receiving information about certain types of messages).

At S230, the back-end application computer server may transmit batches of information about the queued new supplemental electronic note data messages in “near real-time.” For example, the batches of information about the queued new supplemental electronic note messages might be transmitted substantially once per hour. According to some embodiments, the batches of information are transmitted via a secure File Transfer Protocol (“FTP”). Note that due to performance overhead and database lock issues, it might not be practical to transmit information immediately. Moreover, a “maintenance” window might be provided, for example, from 1:00 AM to 3:00 AM during which batch downloads are suspended (e.g., to update systems, verify that all downloads have occurred properly, etc.).

At S240, information may be exchanged, through a communication port via a distributed communication network, with a plurality of remote management system terminals to support an interactive user interface display of the supplemental electronic note data messages. According to some embodiments, the back-end application computer server is further programmed to automatically detect a version of software running on at least one remote management system terminal. In this case, the exchange of information with the remote management system terminal is adjusted based on the detected software version (e.g., to support new features introduced into a new software version).

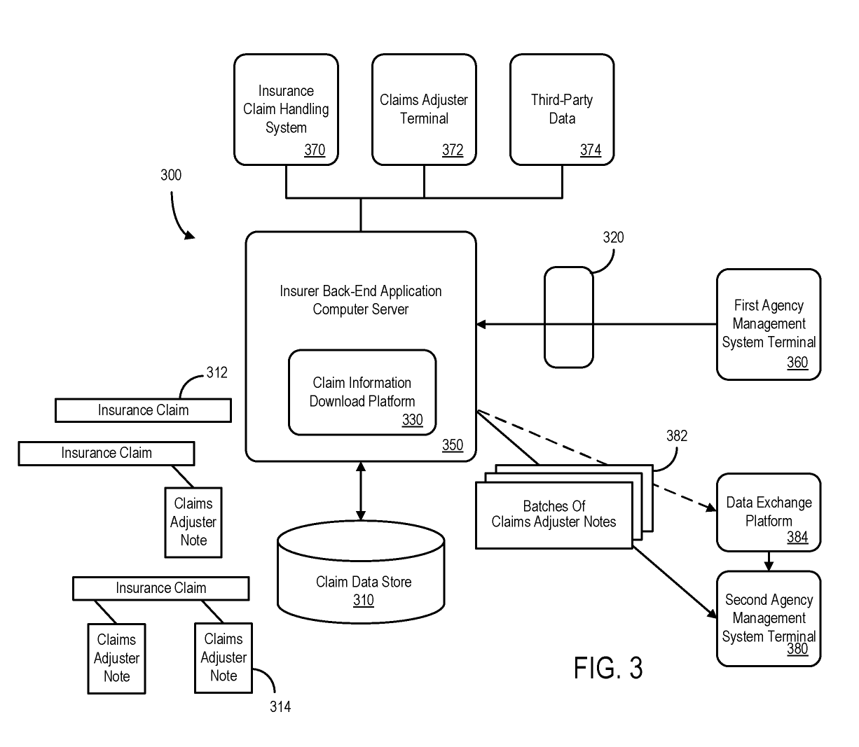

Note that embodiments described herein may be utilized by different types of enterprises. For example, FIG. 3 is a high-level block diagram of an insurer enterprise system 300 according to some embodiments of the present invention. As before, the system 300 includes an insurer back-end application computer server 350 that may access a set of insurance claim records 312 and associated claims adjuster notes 314 in a claim data store 310 (e.g., each record 312 representing a submitted insurance claim and including one or more insurance policy or claim identifiers, characteristic values, attribute variables, etc.). The insurer back-end application computer server 350 may also exchange information with a first agency management system terminal 360 (e.g., via a firewall 320). For example, the insurer back-end application computer server 350 might receive registration information from the first agency management system terminals 360. According to some embodiments, a claim information download platform 330 of the insurer back-end application computer server 350 may facilitate a distribution of batches of claims adjuster notes 382 to a second agency management system terminal 380. According to other embodiments, the claim information download platform 330 and/or the insurer back-end application computer server 350 may route the batches of claims adjuster notes 382 to the second agency management system terminal 380 via a data exchange platform 384 (e.g., as illustrated by a dashed arrow of FIG. 3). Note that the data exchange platform may receive a single batch of claims adjuster notes 382 and, in response to that single batch, arrange for data to be transmitted to plurality of remote agency management system terminals 380. The insurer back-end application computer server 350 might be, for example, associated with a PC, laptop computer, smartphone, an enterprise server, a server farm, and/or a database or similar storage devices. Devices, including those associated with the insurer back-end application computer server 350 and any other device described herein, may exchange information via any communication network which may be one or more of a LAN, a MAN, a WAN, a proprietary network, a PSTN, a WAP network, a Bluetooth network, a wireless LAN network, and/or an IP network such as the Internet, an intranet, or an extranet.

The insurer back-end application computer server 350 may store information into and/or retrieve information from the claim data store 310. The claim data store 310 might, for example, store record identifiers, characteristic values (e.g., claimant names, dates of loss, insurance policy identifiers, etc.), and/or attribute variables. The claim data store 310 may also contain information about past and current interactions with parties (e.g., both claims that have been processed and claims that are currently pending), including those associated with remote communication devices.

According to some embodiments, at least some of the set of record characteristic values are associated with claims adjuster notes 314 (e.g., further describing information about the insurance claim), an insurance claim handling system 370 (e.g., an automated platform that processes different types of insurance claims), a claims adjuster terminal 372 (e.g., where a claims handler or adjuster enters information about an insurance claim—including claims adjuster note 314 data), and/or third-party data 374 (e.g., medical information from a doctor or hospital, vehicle repair estimates, etc.).

According to some embodiments, in contrast to FIG. 1, the enterprise is an insurer, the existing risk associations with entities are insurance policies with insured customers, the “events” processed by the system 300 are insurance claims that have been filed by insured customers, the supplemental electronic note data messages in the claim data store 310 are claims adjuster notes 314, and the remote management system terminals are insurance Agency Management System (“AMS”) terminals 360, 380. By way of example, insurance policies might be associated with automobile insurance, property insurance, General Liability (“GL”) insurance, Workers' Compensation (“WC”) insurance, personal insurance, and/or commercial insurance (e.g., insuring a business).

According to some embodiments, the insurer back-end application computer server 350 may automatically generate a message in response to an electronic data record and a message trigger rule, and the automatically generated message may be a first message type triggered by a first message trigger rule or a second message type triggered by a second message trigger rule (different than the first message trigger rule). In some cases, messages of the first type can include supplemental electronic note data messages (e.g., claims adjuster notes 314) while messages of the second type cannot include supplemental electronic note data messages. According to some embodiments, the first message type is an adjuster assignment message and the second message type might be a claim information update message associated with a First Notice of Loss (“FNOL”), a payment information message, a reserve update message, and/or a claim status update. Moreover, according to some embodiments, each claims adjuster note 314 is associated with a note topic, such as an appraisal, coverage information, payment information, a salvage value, medical information, and/or wage information. In some embodiments, each claims adjuster note 314 might include insured contact information fields, policy information fields, claim occurrence and basic loss information fields, claimant contact information fields, adjuster contact information fields, and/or payment and reserve information fields.

In addition to information about the batches of claims adjuster notes 382, the AMS terminal 380 might, according to some embodiments, further include an agency connectivity dashboard (e.g., graphically showing how many claims are pending, have been approved, etc.), a connections report online, and/or agency download usage reports. According to some embodiments, insurance claims have at least one record characteristic value associated with a loss date, and the trigger rule and/or display of information on an AMS terminal 360, 380 is based at least in part on loss dates.

According to some embodiments, the back-end application computer server 350 is further programmed to facilitate a registration process with the remote management system terminals. That is, insurance agents or agencies might sign-up to receive claim information via the AMS terminals 360, 380. For example, FIG. 4 illustrates an exemplary insurance agency management system claims download registration display 400 that might be associated with various embodiments. In particular, an insurance agent or agency may register via display portion 410 to receive claims download information in near real time in connection with one or more producer codes 420 (note that in some cases, a single insurance agency might be associated with multiple producer codes 420). According to some embodiments, the agent or agency may use selection icons 430 to indicate how the claims download information should be received and finalize his or her selection with a “Submit” icon 450. Such a display 400 might also be used to establish user display preferences (e.g., indicating what types of information should be downloaded, how often downloads should occur, etc.). According to some embodiments, a user may be able to enter a “loss date” for the insurance agency. In this case, the future claim activity will be fed to the AMS system for existing losses (with earlier original loss dates). That is, agents may be able to turn on claims download by loss effective date (e.g., which might, for example, help support agency merger and acquisition activity).

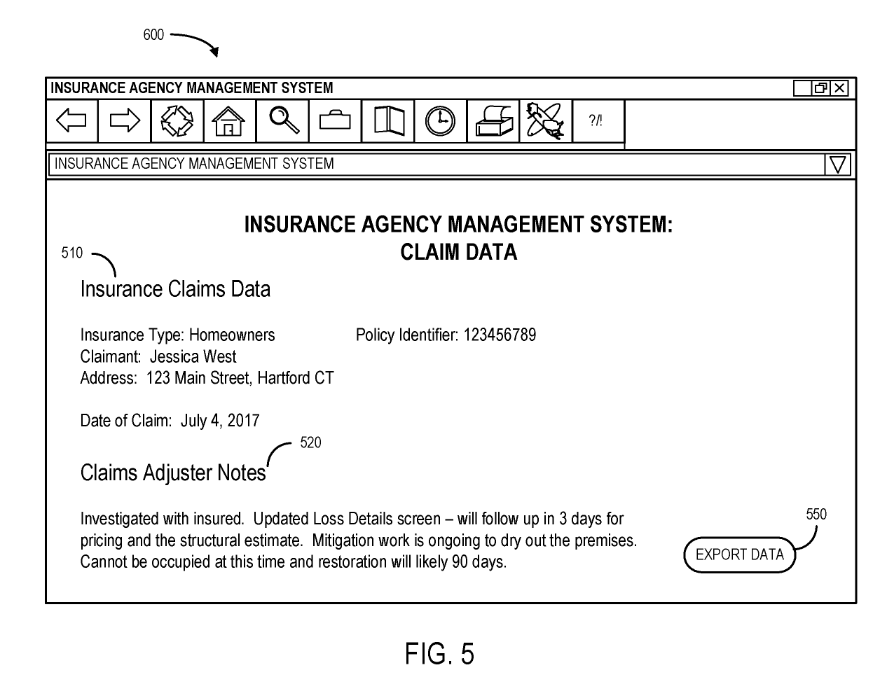

After registration, the insurance agent or agency may use an AMS terminal to received information about claims. For example, FIG. 5 illustrates an exemplary insurance agency management system claim data display 500 according to some embodiments. In particular, the display 500 includes an insurance claims data portion 510 indicating an insurance type, claimant, policy identifier, address, date of claim, etc. In addition, the display 500 includes claims adjuster notes 520 that the agent or agency can use to help an insured understand the current status or resolution of his or claim. According to some embodiments, information from the display 500 may be saved for use by other applications via an “Export Data” icon 550 (e.g., to copy the data to a spreadsheet application, email program, etc.).

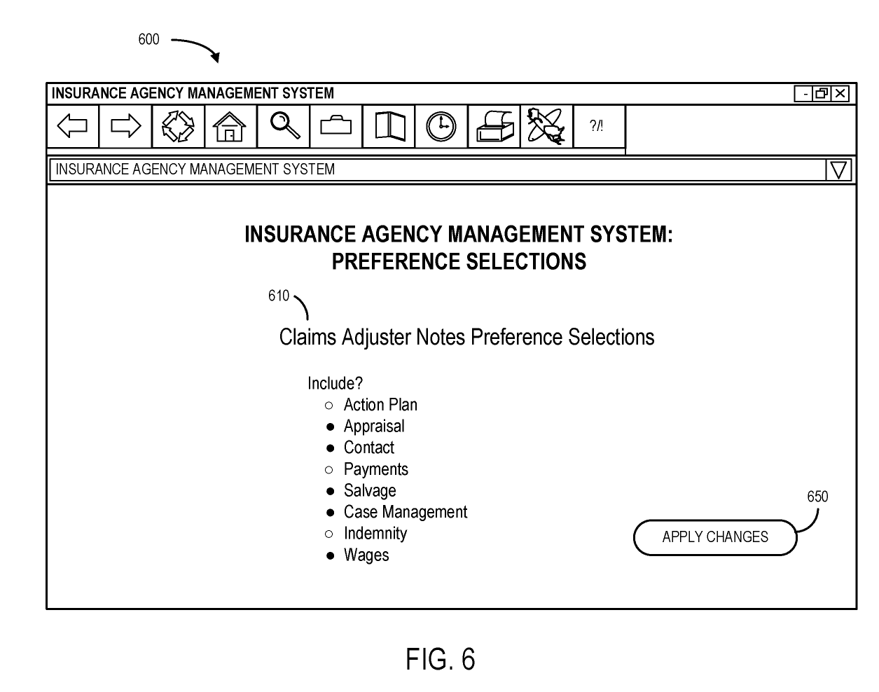

According to some embodiments, an insurance agent or agency is able to customize how claims data is received and/or displayed via AMS terminals. For example, FIG. 6 illustrates an exemplary insurance agency management system preference selections display 600 that might be associated with various embodiments. According to this embodiment, a claims adjuster notes preference selections portion 610 may be used to individually select the types of claim data that are of interest (e.g., via graphical user selection icons). As illustrated in FIG. 6, the agent or agency is interested in receiving information about appraisals, contacts, salvages, case management, and wages (as indicated by the solid selection circles in FIG. 6) but is not interested in receiving information about action plans, payments, and indemnity (as indicated by the empty selection circles in FIG. 6). Note that the data and selections offered in the display 600 are merely used as examples and actually AMS terminals might include selections for any other types of claim information. In this way, the system may provide a customizable, personalized digital experience for insurance agents.

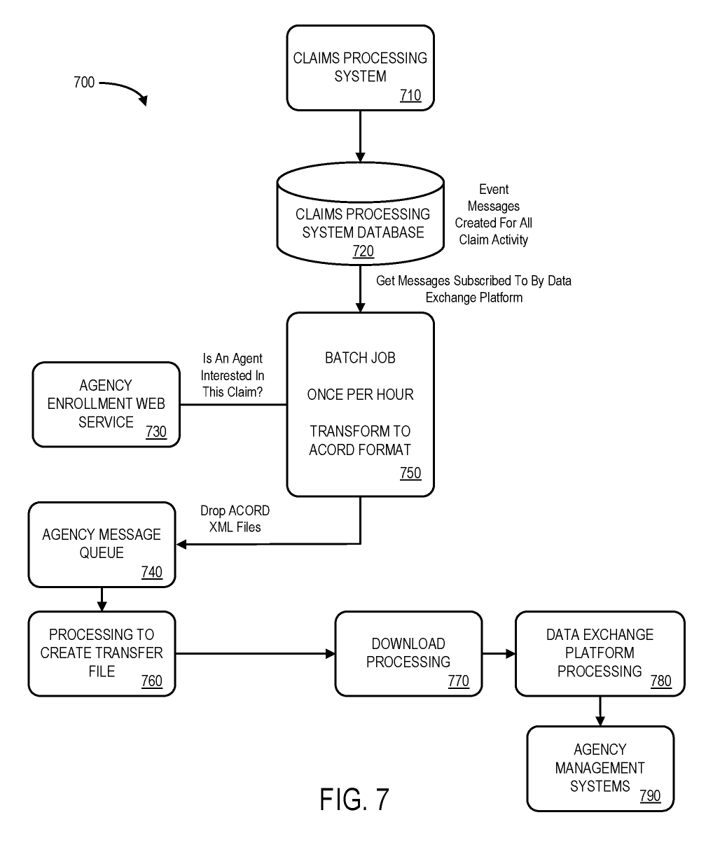

Embodiments may be implemented used any of a number of different network topologies. For example, FIG. 7 is a block architecture diagram of a system 700 in accordance with some embodiments of the present invention. In particular, a server 750 may receive information for a claims processing system 710 via a claims processing system database 720 (where event messages may be created for all claim activity and a message subscription protocol may be implemented). Note that the claims processing system 710 might handle may different types of insurance claims (e.g., automobile insurance, workers' compensation insurance, etc.). The server 750 may perform batch jobs on the claims data (e.g., once per hour) and transform the information to an Association for Cooperative Operations Research and Development (“ACORD”) electronic data format. An agency enrollment web service 730 may help determine if an insurance agent is interested in a particular insurance claim. According to some embodiments, the server 750 drops ACORD XML files to an agency message queue 740 which are then subject to download processing 770 after the items in the queue are processed to create a transfer file 760. The transfer file created at 760 might comprise, for example, electronic data acting as an envelope and address to route the information from the agency message queue 740 as appropriate. Appropriate data exchange platform processing 780 may then be performed such that the appropriate claims data may be displayed via AMS terminals 790. The data exchange platform processing 780 may, for example, convert the transfer file created at 760 into a format/protocol that may be received by the AMS terminals 790.

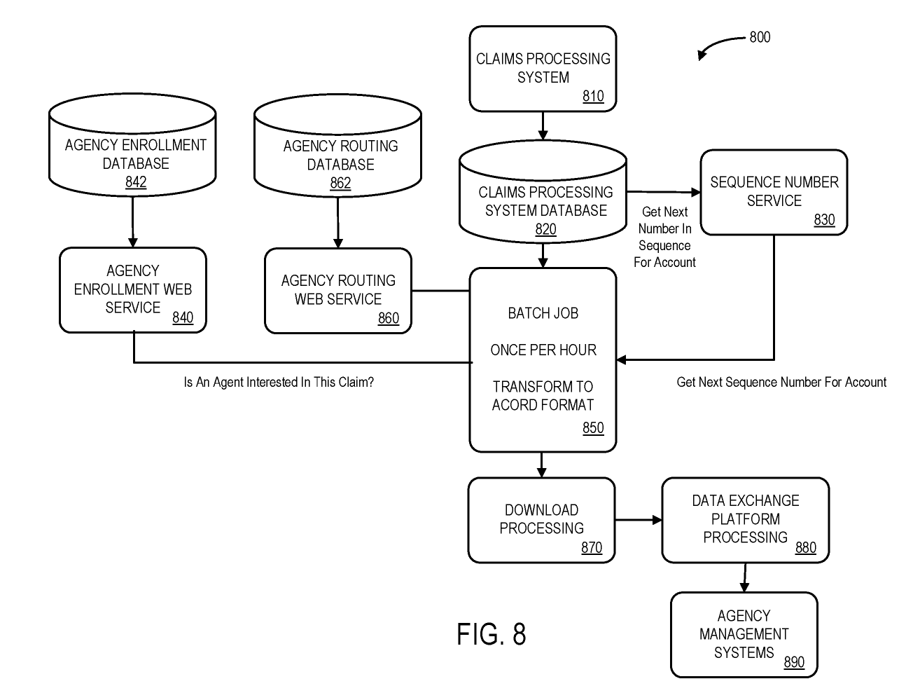

Note that the architecture of FIG. 7 is provided only as an example, and any other network topology might be used instead. For example, FIG. 8 is a block architecture diagram of a system 800 in accordance with another embodiment. As before, a server 850 may receive information for a claims processing system 810 via a claims processing system database 820. In this embodiment, a sequence number service 830 may be utilized to get a next number in sequence for the server 850 in connection with a particular account. The server 850 may perform batch jobs on the claims data (e.g., once per hour) and transform the information to an ACORD electronic data format. An agency enrollment web service 840 may help determine if an insurance agent is interested in a particular insurance claim by accessing an agency enrollment database 842. Moreover, an agency routing web service 860 may use an agency routing database 862 to help route information to agencies as appropriate. According to some embodiments, the server 850 drops ACORD XML files for download processing 870 and subsequent data exchange platform processing 880 such that the appropriate claims data may be displayed via AMS terminals 890.

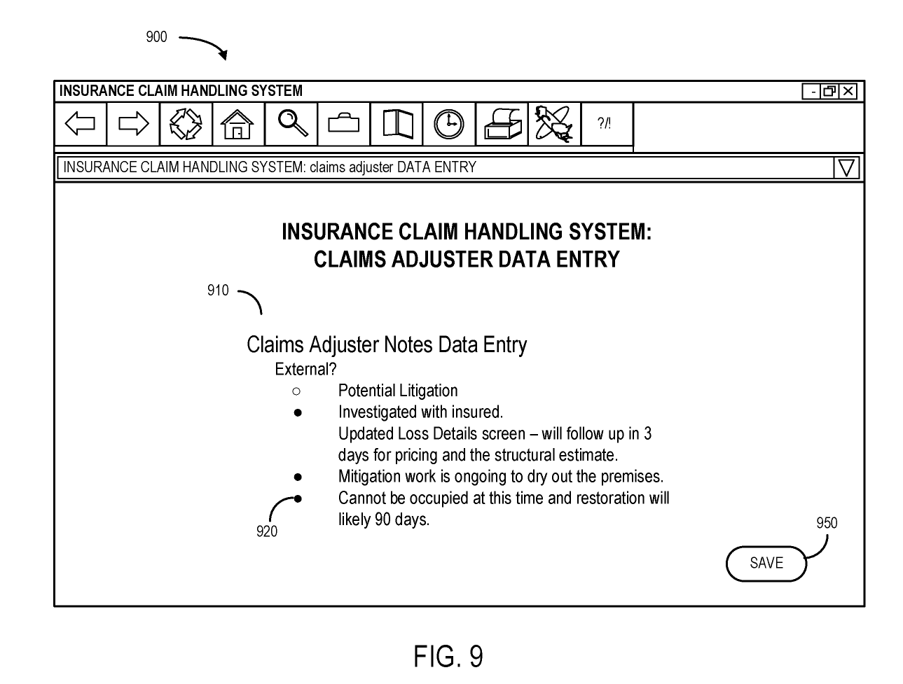

According to some embodiments, the claims processing system 810 may let an insurance adjuster or claims handler enter claim notes further describing the details about a claim and/or the steps taken to resolve the claim. For example, FIG. 9 illustrates an exemplary insurance claim handling system claims adjuster data entry display 900 that might be associated with various embodiments. In particular, the display 900 includes a claims adjuster notes data entry portion 910 where the adjuster or handler can enter note about the claim (e.g., text, images, audio clips, video files, links to other information, etc.). Moreover, the adjuster or claim handler can manually indicate via icons 920 whether or not the entered information should be available externally (e.g., via AMS terminals). Note that some information, such as private and/or personal medical information or Personally Identifiable Information (“PII”), might only be available internally to an insurer enterprise. In some embodiments, certain types of information default to externally available or not externally available. According to some embodiments, a claims handler is not allowed to override this default. The adjuster or handler can then arrange to apply his or her selections via a “Save” icon 950.

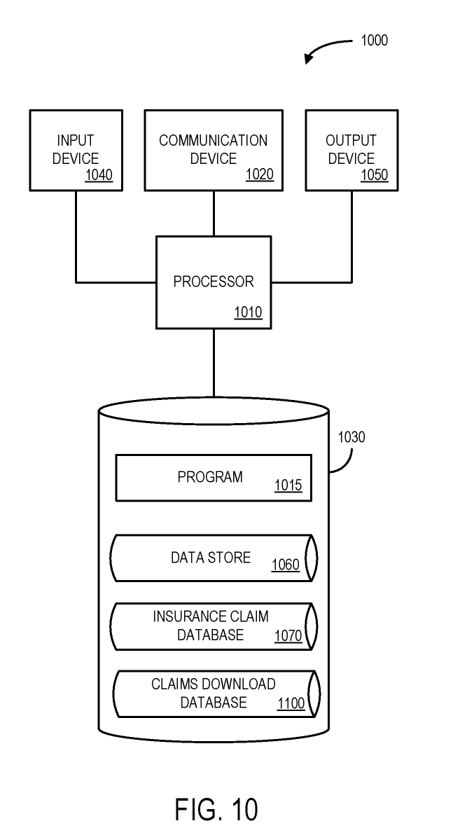

Embodiments described herein may comprise a tool that facilitates the distribution of information supplemental electronic note data messages and may be implemented using any number of different hardware configurations. For example, FIG. 10 illustrates a back-end application computer server 1000 that may be, for example, associated with the systems 100, 300 of FIGS. 1 and 3, respectively. The back-end application computer server 1000 comprises a processor 1010, such as one or more commercially available Central Processing Units (“CPUs”) in the form of one-chip microprocessors, coupled to a communication device 1020 configured to communicate via a communication network (not shown in FIG. 10). The communication device 1020 may be used to communicate, for example, with one or more remote administrator computers and/or communication devices (e.g., PCs and smartphones). Note that communications exchanged via the communication device 1020 may utilize security features, such as those between a public internet user and an internal network of the enterprise. The security features might be associated with, for example, web servers, firewalls, and/or PCI infrastructure. The back-end application computer server 1000 further includes an input device 1040 (e.g., a mouse and/or keyboard to enter information about insurance claims and/or insurance agents, etc.) and an output device 1050 (e.g., to output reports regarding system usage).

The processor 1010 also communicates with a storage device 1030. The storage device 1030 may comprise any appropriate information storage device, including combinations of magnetic storage devices (e.g., a hard disk drive), optical storage devices, mobile telephones, and/or semiconductor memory devices. The storage device 1030 stores a program 1015 and/or an existing association review tool or application for controlling the processor 1010. The processor 1010 performs instructions of the program 1015, and thereby operates in accordance with any of the embodiments described herein. For example, the processor 1010 may access electronic data records each representing an event associated with an existing risk association between an enterprise and an entity. Each electronic data record may be associated with a record identifier and a set of record characteristic values. Moreover, at least some of the electronic data records may be linked to supplemental electronic note data messages. The processor 1010 may automatically queue new supplemental electronic note data messages in accordance with at least one trigger rule. The processor 1010 may also automatically transmit batches of information about the queued new supplemental electronic note data messages in near real-time. According to some embodiments, information may be exchanged with a plurality of remote management system terminals, via a distributed communication network, to support an interactive user interface display of the supplemental electronic note data messages.

The program 1015 may be stored in a compressed, uncompiled and/or encrypted format. The program 1015 may furthermore include other program elements, such as an operating system, a database management system, and/or device drivers used by the processor 1010 to interface with peripheral devices.

As used herein, information may be “received” by or “transmitted” to, for example: (i) the back-end application computer server 1000 from another device; or (ii) a software application or module within the back-end application computer server 1000 from another software application, module, or any other source.

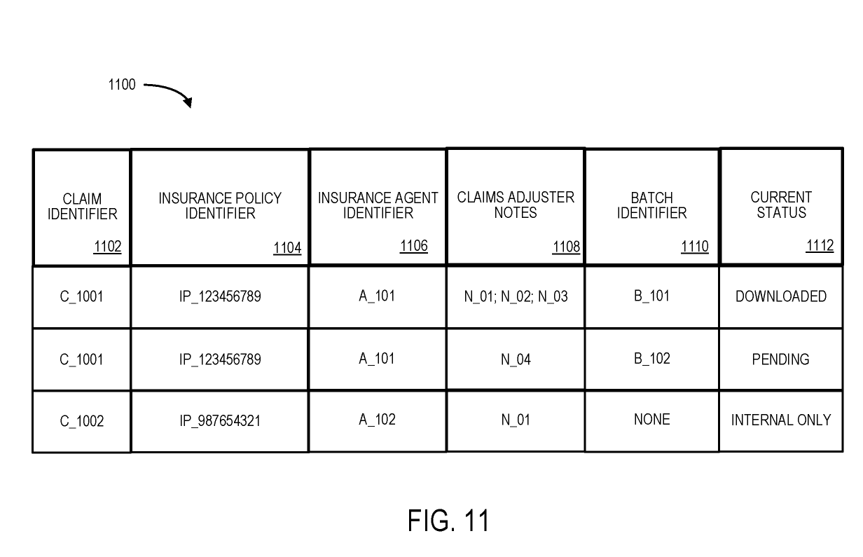

In some embodiments (such as shown in FIG. 10), the storage device 1030 further stores a data store 1060 (e.g., containing information about insurance agency registrations and/or display preferences), an insurance claim database 1070 (e.g., containing claim details, claim notes, etc.), and a claims download database 1100. Examples of a database that might be used in connection with the back-end application computer server 1000 will now be described in detail with respect to FIG. 11. Note that the database described herein is only an example, and additional and/or different information may be stored therein. Moreover, various databases might be split or combined in accordance with any of the embodiments described herein. For example, the program 1015 and claims download database 1100 might be combined and/or linked to each other within the storage unit 1030.

Referring to FIG. 11, a table is shown that represents the claims download database 1100 that may be stored at the back-end application computer server 1000 according to some embodiments. The table may include, for example, entries identifying data to be downloaded for display via AMS terminals. The table may also define fields 1102, 1104, 1106, 1108, 1110, 1112 for each of the entries. The fields 1102, 1104, 1106, 1108, 1110, 1112 may, according to some embodiments, specify: a claim identifier 1102, an insurance policy identifier 1104, an insurance agent identifier 1106, claim adjuster notes 1108, a batch identifier 1110, and current status 1112. The claims download database 1100 may be created and updated, for example, as insurance claims are filed by insureds and/or processed by an insurance enterprise.

The electronic record identifier 1102 may be, for example, a unique alphanumeric code identifying an insurance claim that has been filed by an insured in connection with the insurance policy identifier 1104. The insurance agent identifier 1106 might indicate, for example, the agent who sold that insurance policy to the insured (e.g., and who might want to helps the insured find answers to questions about his or her insurance claim). The claim adjuster notes 1108 indicate one or more identifiers indicating supplemental information that has been entered into the system in connection with the claim identifier 1102. The batch identifier 1110 might be associated with a “batch” or set of computer files that will be downloaded for display via an AMS terminal. For example, the system might collect three files (associated with three different claim notes) that were creating during the last hour that will be downloaded for AMS terminal display in a single batch of information. The current status 1112 might indicate whether or not the batch is pending to download for AMS terminal display or already has been download (or, in some cases, will not be downloaded at all because the information is for internal use only). Note that in some cases, information might be pulled from an insured when a query or report is requested by an agent (instead of being transmitted in hourly batches). Such an implementation might be, for example, exposed as a new service to be provided via the AMS terminals.

Thus, some embodiments may automatically make supplemental electronic note data messages available via remote management system terminals in a timely and accurate fashion. According to some embodiments, an insurer back-end application computer server, a claim information download platform, and/or a data exchange platform may facilitate a scalable distribution of claim adjuster notes to AMS terminals. For example, in a weather catastrophe or other emergency embodiments may facilitate a distribution of information thousands of claims in an efficient manner. In this way, the need for a substantial volume of telephone calls, facsimile responses to client questions, etc. may be reduced. Moreover, in some embodiments AMS terminals may be configured to automatically respond to information from an insurer back-end application computer server and/or claim information download platform. For example, workflow processes might be automatically initiated, calendar events might be automatically scheduled, etc., to further streamline and improve responsiveness to client needs.

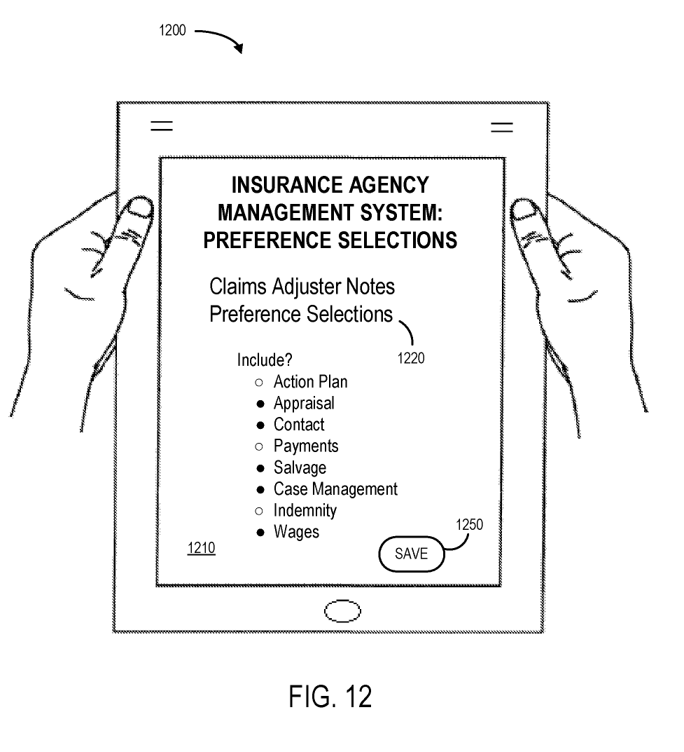

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications. Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to particular types of communication channels, embodiments may instead be associated with other types of communications (e.g., chat implementations, web-based messaging, etc.). Similarly, although a certain types of record characteristic values were described in connection some embodiments, other types of data might be used instead. Still further, the displays and devices illustrated herein are only provided as examples, and embodiments may be associated with any other types of user interfaces. For example, FIG. 12 illustrates a handheld tablet computer 1200 presenting a preference selections display 1210 according to some embodiments. The display 1210 might be provided to a claims adjusters and give him or her options 1220 about which types of information he or she is interested in receiving (or is not interested in receiving). These selected options 1220 may then be saved via selection of a touch icon 1250.

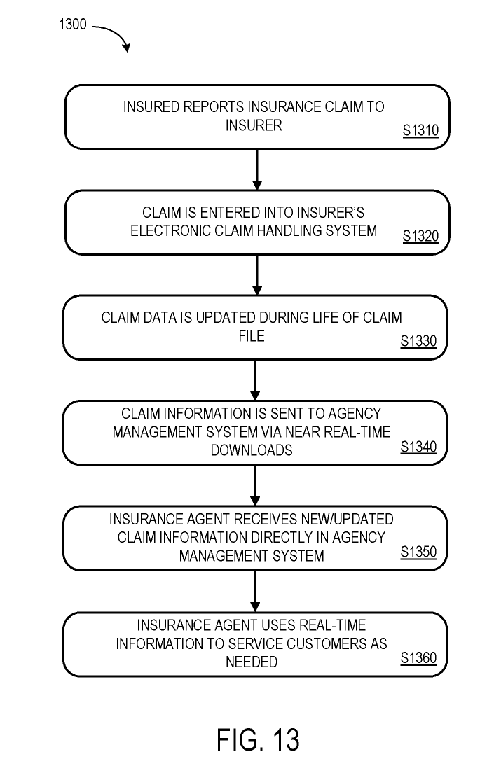

Note that embodiments described herein might be used in connection with a number of different types of business process flows. For example, FIG. 13 illustrates an overall process 1300 in accordance with some embodiments. At S1310, an insured reports an insurance claim to an insurer. For example, he or she might have originally purchased a homeowner's insurance policy from the insurer via an insurance agent. At S1320, the claim is entered into the insurer's electronic claim handling system. For example, the homeowner's might have suffered damage during a storm and contacted the insurer with information with initial details about his or her insurance claim. At S1330, the claim data is updated during the life of the claim file (e.g., as the claims adjuster visits to home to assess damages, receives repair estimates from contractors, etc.). In some cases, the claim data update entered at S1330 might include claims adjuster notes (e.g., “I visited the site on Jul. 1, 2017 and verified the severe roof damage.”). At S1340, the claim information, including claims adjuster notes, is sent to an AMS via near real-time downloads (e.g., batches of information associated with one or more insurance claims, insurance policies, etc. might be downloaded once per hour). At S1350, the insurance agent receives the new and/or updated claim information directly in his or her AMS terminal. At S1360, the agent may use the real-time information to service customers as needed. For example, if the homeowner has a question about a scheduled repair to his or her roof, he or she may likely call the insurance agent (because that is where he or she originally purchased the insurance policy). In accordance with embodiments described herein, the insurance agent may be able to answer the homeowner's questions without needing to contact the insurer (saving everyone the time and costs associated with this additional step). Moreover, the accuracy of information provided to the homeowner may be improved (by avoiding unnecessary communications).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system to distribute information for an enterprise via an automated back-end application computer server, comprising:
(a) at least one data store containing electronic data records each representing an event associated with an existing risk association between the enterprise and an entity, wherein each electronic data record is associated with a record identifier and a set of record characteristic values, and further wherein at least some of the electronic data records are linked to supplemental electronic note data messages;
(b) the back-end application computer server, coupled to the data store, programmed to:
(i) access the set of electronic data records in the data store,
(ii) automatically generate a message in response to an electronic data record and a message trigger rule, wherein the automatically generated message may be a first message type triggered by a first message trigger rule or a second message type triggered by a second message trigger rule, different than the first message trigger rule, and further wherein messages of the first type can include supplemental electronic note data messages while messages of the second type cannot include supplemental electronic note data messages,
(iii) automatically queue new supplemental electronic note data messages in accordance with at least one note trigger rule, and
(iv) automatically transmit batches of information about the queued new supplemental electronic note data messages in near real-time; and
(c) a communication port coupled to the back-end application computer server to facilitate an exchange of information with a plurality of remote management system terminals, via a distributed communication network, supporting an interactive user interface display including the supplemental electronic note data messages.

2. The system of claim 1, wherein the communication port is to route some batches of information about queued new supplemental electronic note data messages directly to the remote management system terminals while other batches are routed through a data exchange platform.

3. The system of claim 2, wherein the data exchange platform receives a single batch of information about queued supplemental electronic note data messages and, in response to that single batch, arranges for data to be transmitted to plurality of remote management system terminals.

4. The system of claim 1, wherein the back-end application computer server is further programmed to automatically detect a version of software running on at least one remote management system terminal, wherein the exchange of information with the remote management system terminal is adjusted based on the detected software version.

5. The system of claim 1, wherein each supplemental electronic note data message is associated with a note type and the trigger rule is based at least in part on the note type.

6. The system of claim 5, wherein the trigger rule is further based on user preference values stored in connection with the remote management system terminals.

7. The system of claim 1, wherein the batches of information about the queued new supplemental electronic note messages are transmitted substantially once per hour.

8. The system of claim 7, wherein the batches of information are transmitted via a secure file transfer protocol.

9. The system of claim 1, wherein the back-end application computer server is further programmed to facilitate a registration process with the remote management system terminals.

10. The system of claim 1, wherein the enterprise is an insurer, the existing risk associations with entities are insurance policies with insured customers, the events are insurance claims that have been filed by insured customers, the supplemental electronic note data messages are claims adjuster notes, and the remote management system terminals are insurance agency management system terminals.

11. The system of claim 10, wherein the insurance policies are associated with at least two of: (i) automobile insurance, (ii) property insurance, (iii) general liability insurance, (iv) workers' compensation insurance, (v) personal insurance, and (vi) commercial insurance.

12. The system of claim 10, wherein of the first message type is an adjuster assignment message and the second message type is at least one of: (i) a claim information update message associated with a first notice of loss, (ii) a payment information message, (iii) a reserve update message, and (v) a claim status update.

13. The system of claim 12, wherein claims adjuster notes are associated with a note topic, including at least two of: (i) an appraisal, (ii) coverage information, (iii) payment information, (iv) a salvage value, (v) medical information, and (vi) wage information.

14. The system of claim 10, wherein claims adjuster notes include at least two of: (i) insured contact information fields, (ii) policy information fields, (iii) claim occurrence and basic loss information fields, (iv) claimant contact information fields, (v) adjuster contact information fields, and (vi) payment and reserve information fields.

15. The system of claim 10, wherein the interactive user interface display further includes at least one of: (i) an agency connectivity dashboard, (ii) a connections report online, and (iii) agency download usage reports.

16. The system of claim 10, wherein insurance claims have at least one record characteristic value associated with a loss date, and the trigger rule may be based at least in part on loss dates.

17. A computerized method to distribute information for an enterprise via an automated back-end application computer server, comprising:
receiving, at a back-end application computer server from at least one data store, electronic data records each representing an event associated with an existing risk association between the enterprise and an entity, wherein each electronic data record is associated with a record identifier and a set of record characteristic values, and further wherein at least some of the electronic data records are linked to supplemental electronic note data messages;
automatically queuing, by the back-end application computer server, new supplemental electronic note data messages in accordance with at least one trigger rule;
automatically transmitting, by the back-end application computer server, batches of information about the queued new supplemental electronic note data messages in near real-time; and
exchanging, through a communication port via a distributed communication network, information with a plurality of remote management system terminals to support an interactive user interface display of the supplemental electronic note data messages.

18. The method of claim 17, wherein each supplemental electronic note data message is associated with a note type and the trigger rule is based at least in part on the note type and user preference values stored in connection with the remote management method terminals.

19. The method of claim 17, wherein the batches of information about the queued new supplemental electronic note messages are transmitted substantially once per hour.

20. The method of claim 17, wherein the enterprise is an insurer, the existing risk associations with entities are insurance policies with insured customers, the events are insurance claims that have been filed by insured customers, the supplemental electronic note data messages are claims adjuster notes, and the remote management method terminals are insurance agency management method terminals.

21. A system to distribute information for an insurance enterprise via an automated back-end application computer server, comprising:
(a) at least one data store containing electronic data records each representing insurance claim associated with an existing insurance policy between the insurance enterprise and an insured, wherein each electronic data record is associated with a record identifier and a set of record characteristic values, and further wherein at least some of the electronic data records are linked to supplemental claims adjuster notes;
(b) the back-end application computer server, coupled to the data store, programmed to:
(i) access the set of electronic data records in the data store,
(ii) automatically generate a message in response to an electronic data record and a message trigger rule, wherein the automatically generated message may be a first message type triggered by a first message trigger rule or a second message type triggered by a second message trigger rule, different than the first message trigger rule, and further wherein messages of the first type can include claims adjuster notes while messages of the second type cannot include claims adjuster notes,
(iii) automatically queue new claims adjuster notes in accordance with at least one note trigger rule, and
(iv) automatically transmit batches of information about claims adjuster notes in near real-time; and
(c) a communication port coupled to the back-end application computer server to facilitate an exchange of information with a plurality of remote management system terminals supporting an interactive user interface display including the claims adjuster notes.

22. The system of claim 21, wherein the record characteristic values include an insurance claim effective loss date, and the note trigger rules is based at least in part on the insurance claim effective loss date.
